(19) United States
(12) Patent Application Publication
(10) Pub. No.: US 2026/0339753 A1
(43) Pub. Date: Oct. 29, 2026

(54) SYNCHRONIZATION OF JOBS

(71) Applicant: Nokia Solutions and Networks Oy, Espoo (FI)

(72) Inventors: Zhi Xu GAO, Hangzhou (CN); Jian Jun YU, Hangzhou (CN); Chunhong WANG, Hangzhou (CN); Peng Cheng WANG, Hangzhou (CN)

(21) Appl. No.: 18/998,915

(22) PCT Filed: Aug. 4, 2022
(86) PCT No.: PCT/CN2022/110362

§ 371 Date: Jan. 27, 2025

(51) Int. Cl. G06F 9/52; G06F 9/48

(52) U.S. Cl. CPC G06F 9/52; G06F 9/4881

(57) ABSTRACT

Example embodiments of the present disclosure relate to synchronization of jobs. A device executes a first job on which a second job depends. If the first job is completed, the device determines whether a first execution condition for the second job is met by executing a dispatching job corresponding to the first job. If the first execution condition is met, the device triggers execution of the second job by executing the dispatching job.

### FIELD

Various example embodiments of the present disclosure generally relate to the field of computer and in particular, to methods, devices, apparatuses and computer readable storage medium for synchronization of jobs.

### BACKGROUND

There are various jobs in a computing system. Some of these jobs may have dependencies. A job may depend on one or more other jobs. For example, the job may need to read from memory data written by the one or more other jobs. In this situation, the job should be executed after the one or more jobs are completed. A synchronization mechanism is needed to ensure that the job is executed correctly.

### SUMMARY

In a first aspect of the present disclosure, there is provided a device. The device comprises at least one processor; and at least one memory storing instructions that, when executed by the at least one processor, cause the device at least to perform: executing a first job on which a second job depends; in accordance with a determination that the first job is completed, determining whether a first execution condition for the second job is met by executing a dispatching job corresponding to the first job; and in accordance with a determination that the first execution condition is met, triggering execution of the second job by executing the dispatching job.

In a second aspect of the present disclosure, there is provided a method. The method comprises: executing a first job on which a second job depends; in accordance with a determination that the first job is completed, determining whether a first execution condition for the second job is met by executing a dispatching job corresponding to the first job; and in accordance with a determination that the first execution condition is met, triggering execution of the second job by executing the dispatching job.

In a third aspect of the present disclosure, there is provided an apparatus. The apparatus comprises: means for executing a first job on which a second job depends; means for in accordance with a determination that the first job is completed, determining whether a first execution condition for the second job is met by executing a dispatching job corresponding to the first job; and means for in accordance with a determination that the first execution condition is met, triggering execution of the second job by executing the dispatching job.

In a fourth aspect of the present disclosure, there is provided a computer readable medium. The computer readable medium comprises instructions stored thereon for causing an apparatus to perform at least the method according to the first aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates a schematic block diagram of a device according to some example embodiments of the present disclosure;

FIG. 1B illustrates an example communication environment in which some example embodiments of the present disclosure can be implemented;

FIG. 2 illustrates example jobs according to some example embodiments of the present disclosure;

FIG. 3 illustrates an example procedure of synchronization processing according to some example embodiments of the present disclosure;

FIG. 4 illustrates an example process of job configuration according to some example embodiments of the present disclosure;

FIG. 5 illustrates an example process of job scheduling and execution according to some example embodiments of the present disclosure;

FIG. 6 illustrates an example process of handling synchronization jobs according to some example embodiments of the present disclosure;

FIG. 7 illustrates example dependencies of communication jobs according to some example embodiments of the present disclosure;

FIG. 8 illustrates a flowchart of a method implemented at a device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, a job depending on another job means that execution of the job needs outcome of the other job. Therefore, the other job is a prerequisite job or a predecessor job for the job. Moreover, an independent job and a dependent job are relative concepts. For example, a job depending on another job may be an independent job for a third job.

### Example Environment

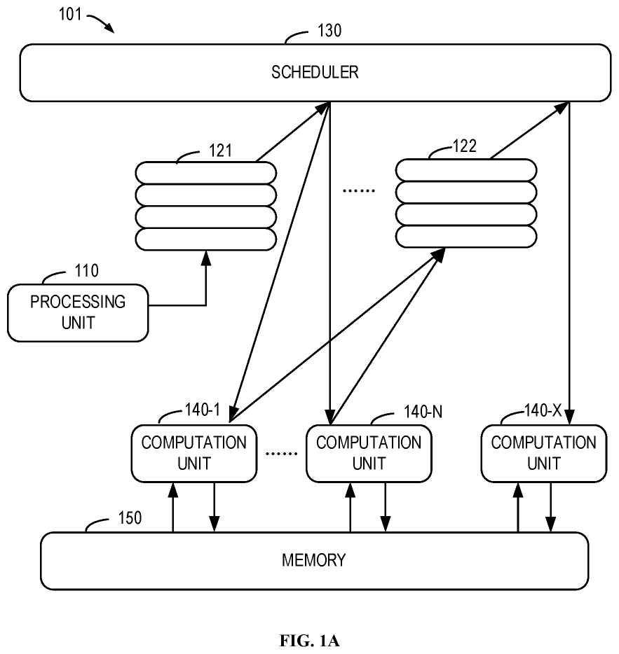

FIG. 1A illustrates a schematic block diagram of a device 101 according to some example embodiments of the present disclosure. In general, the device 101 is a multi-process operating system comprising a processing unit 110, a scheduler 130, hardware queues 121 and 122, a memory 150 and computation units 140-1, . . . , 140-N, 140-X, where N and X are positive integers. The computation units 140-1, . . . , 140-N, 140-X are collectively referred to as “computation units 140″ or individually referred to as ”computation unit 140″. A variety of jobs may be executed in the device 101. A job is a unit of execution, which executes in a computation unit.

The processing unit 110, for example a central processing unit (CPU), is used to configurate jobs. The processing unit 110 prepares parameters of the jobs ahead of their real-time execution, and pushes each of the jobs into an appropriate queue of the scheduler 130 via software programming. The queues 121 and 122 are used to store the jobs prepared by the processing unit 110.

The scheduler 130 is used to schedule and dispatch the jobs. The scheduler 130 may pop a job in its input queues and dispatches the job to a computation unit 140 when preconditions of the job are satisfied. The computation unit 140, for example a digital signal processor (DSP), is used to execute the jobs. The programmed instructions of a job combined with its input data can be executed in the computation unit 140 to perform a designed functionality of the job.

A job may depend on one or more other jobs. Accordingly, jobs in the device 101 may be classified into two categories: independent jobs and dependent jobs. The independent jobs shall not affect each other and can be executed in parallel. A dependent job is triggered after its prerequisite jobs are complete. Therefore, a synchronization among these jobs is introduced to ensure that the flow of dependent and independent jobs is correct.

As an example, the processing unit 110 may prepare job 1 to job N as well as a job X and push job 1 to job N to the corresponding queue. Then, the scheduler 130 may pop the job 1 to job N and submits them to the computation units 140-1, . . . , 140-N, separately. The job 1 to job N execute simultaneously on different computation units. The job 1 to job N may write data separately to the memory 150 and the job X needs to read the data written by the job 1 to job N. In this situation, a synchronization of these jobs is implemented to make sure the job X reads the correct data.

It is to be understood that components of the device 101 are only for the purpose of illustration without suggesting any limitation to the protection scope of the present disclosure. The device 101 may comprise any suitable components configured to implementing example embodiments of the present disclosure. Moreover, the number of processing units, schedulers, hardware queues, computation units in FIG. 1A is shown for the purpose of illustration without any limitation to the protection scope of the present disclosure.

The device 101 may be used in any suitable environment, which needs synchronization among jobs. For example, the device 101 may be used in a data storage environment which needs synchronization among data storage jobs.

In some example embodiments, the device 101 may be used in a communication environment to synchronize jobs for communication between the device 101 and at least a further device. FIG. 1B illustrates an example communication environment 100 in which some example embodiments of the present disclosure can be implemented. In the communication environment 100, the device 110 and a device 102 can communicate with each other.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some example embodiments, the device 101 may serve the device 102. The serving area of the device 101 may be referred to as a cell 105. Although a cell 105 is shown in FIG. 1B, the device 101 may provide more than one cells. The jobs in the device 101 are used for communication in these cells. Moreover, in addition to device 102, the environment 100 may include more devices communicating with the device 101.

In some example embodiments, the device 101 may include a network device, for example an LTE base station or an NR base station. In the physical layer upon the device 101 (for example, upon a system-on-chip, SOC), there are many jobs with their own functionalities to support massive cells (such as 24, 48, 64 cells) with different configurations.

As mentioned above, synchronization among jobs is needed to ensure the correct flow of independent and dependent jobs. For example, there are four hardware-based synchronization mechanisms.

A first mechanism is called continued job dependencies mechanism. In this mechanism, a hardware queue is reserved to hold jobs. Next, both the dependent job and the independent jobs are prepared in accordance with their designated functionalities. The independent jobs are marked as continued jobs. Those independent jobs and the dependent job are added to the rear of the same hardware queue. The scheduler schedules and dispatches those independent jobs into the same computation unit one by one. Thereafter, the dependent job is scheduled and dispatched correctly.

One disadvantage of the continued job dependencies mechanism is extremely poor parallelism for the independent jobs, which are executed sequentially. Another disadvantage is high requirement for hardware queues. For example, in a communication environment where massive cells are needed to support in an SoC, thousands of hardware queues are required to support many dependent jobs in a time, since there are hundreds of dependent jobs in one cell.

A second mechanism is called job completion dependencies mechanism, which provides a way for a job to wait for all its previous jobs in the same queue to complete. In this mechanism, a hardware queue is reserved to hold jobs. Next, both the dependent job and the independent jobs are prepared in accordance with their designated functionality. Those independent jobs and the dependent job are added to the same hardware queue. In the following stage, the scheduler schedules and dispatches those independent jobs into the different computation units. After that, the scheduler checks if the independent jobs are complete. When those independent jobs are all complete, the dependent job is scheduled and dispatched correctly.

The main disadvantage of job completion dependencies mechanism is high requirement for hardware queues. For example, in a communication environment where massive cells are needed to support in an SoC, thousands of hardware queues are required to support many dependent jobs in a time, since there are hundreds of dependent jobs in one cell.

A third mechanism is called counter-based dependencies mechanism, which provides a way for a job to wait for a hardware counter to reach zero from a positive initial value. In this mechanism, a hardware queue is reserved to hold jobs. A hardware counter is reserved and assigned to the independent jobs. Those independent jobs and the dependent job are added to the hardware queue. In the following stage, the scheduler schedules and dispatches those independent jobs into the different computation units. The hardware counter is decreased by one upon completion of each independent job. The scheduler checks if the hardware counter reaches zero. When the hardware counter reaches zero, the dependent job is scheduled and dispatched correctly.

The main disadvantage of the job completion dependencies mechanism is high requirement for hardware counters. For example, in a communication environment where massive cells are needed to support in an SoC, thousands of hardware counters are required to support many dependent jobs in a time, since there are hundreds of dependent jobs in one cell. In addition, the cost of introducing thousands of hardware counters and their related infrastructure, such as hardware queues, into an SoC is very expensive. Therefore, this mechanism is not an economic choice.

A fourth mechanism is called time-based dependencies mechanism. In this mechanism, the dependent job is scheduled and dispatched after an estimated duration ends. In practice, it is very hard to estimate accurate durations with the nanosecond granularity of a job. If the estimation error of an independent job is big, unexpected behaviors may occur. Therefore, the time-based dependencies mechanism is unfeasible for time sensitive environment, for example, the communication environment.

In these hardware-based mechanisms, the number of synchronization resources consumed is proportional to the number of dependent jobs. In the environment with many jobs, the limited hardware resources in an SoC are hard to support synchronization of these jobs. For example, in the communication environment where massive cells with different configurations are supported, the hardware resources in the SoC may be not sufficient.

### Work Principle and General Procedure

According to some example embodiments of the present disclosure, there is provided a solution for synchronization of jobs. In this solution, a first job is executed. If it is determined that the first job is completed, a dispatching job corresponding to the first job is executed. The dispatching job determines whether an execution condition for at least one job depending on the first job is met. If the execution condition for a second job of the at least one job is met, the dispatching job triggers execution of the second job.

In this way, a dispatching job is introduced to ensure that a dependent job is executed correctly. Instead of hardware resources, a software implementation is employed to synchronize dependent and independent jobs. Restrictions of hardware resources (for example, hardware queues, hardware counters) are reduced. As such, a synchronization mechanism is achieved with reduced cost. For example, the demand for more powerful but expensive SoC is avoided. Moreover, the execution condition can be defined in a flexible way.

Example embodiments of the present disclosure will be described in detail below with reference to the accompanying drawings.

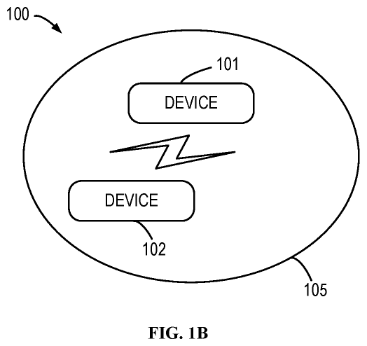

FIG. 2 illustrates example jobs in the device 101 according to some example embodiments of the present disclosure. There are jobs 230-1, 230-2, 230-3, . . . , 230-n, which are collectively referred to as jobs 230 or individually referred to as job 230, where n is a positive integer. The jobs 230 are independent from each other and thus can be executed in an arbitrary order, for example in parallel. There are jobs 240-1, 240-2, 240-3, . . . , 240-m, which are collectively referred to as jobs 240 or individually referred to as job 240, where m is a positive integer. A job 240 is dependent on one or more of the jobs 230.

For purpose of illustration without suggesting any limitation, the jobs 230 may be referred to as independent jobs 230 and the jobs 240 may be referred to as dependent jobs 240. Moreover, the jobs 230 and 240 are designed to implement expected functionalities related to the environment where the device 101 is used. For example, in the example environment 100, the jobs 230 and 240 are used for communication between the device 101 and the device 102. Therefore, the jobs 230 and 240 are functional jobs.

A job 240 may depend on more than one job 230. Alternatively, or in addition, a job 230 may be depended by more than one job 240. In the example of FIG. 2, the job 240-1 depends on the jobs 230-1 and 230-2. The job 240-2 depends on the jobs 230-1 and 230-3. The job 240-3 depends on the 230-3. The job 240-m depends on the jobs 230-3 and 230-n. It is to be understood that the dependencies of jobs shown in FIG. 2 are for the purpose of illustration without suggesting any limitation.

It is to also be understood that a job 240 is not limited to a single job. A job 240 may refer to a collection of jobs which depend on the same independent jobs. For example, the job 240-1 may comprise a plurality of jobs which depend on the jobs 230-1 and 230-2.

Synchronization dispatching (SD) jobs 220-1, 220-2, 220-3, . . . , 220-n, which are collectively referred to as SD jobs 220 or individually referred to as SD job 220, are used to handle synchronization of the functional jobs. As shown in FIG. 2, an independent job 230 is configured with a corresponding SD job 220. The SD job 220 is configured to check the execution conditions for jobs 240 depending on the job 230 corresponding to the SD job 220 and trigger execution of the job 240 for which the execution condition is met. For example, the SD job 220-1 corresponding to the job 230-1 is configured to check the execution conditions for the jobs 240-1 and 240-2. The SD job 220-2 corresponding to the job 230-2 is also configured to check the execution condition for the job 240-1.

The execution conditions for the dependent jobs 240 may be defined in any suitable manner. As an example, a counter implemented by software may be used as a state indication of the execution condition. Accordingly, the execution condition may be defined as the counter reaching a specified value. As another example, a bitmap may be used as a state indication of the execution condition. A bit in the bitmap corresponds to a job 230 on which a job 240 is dependent. Accordingly, the execution condition may be defined as bits in the bitmap having a specified value, such as 0. Therefore, in the example embodiments of the present disclosure, the execution condition for the dependent job can be customized in a flexible way.

The execution condition can be defined and the state indication of the execution condition can be initialized in any suitable manner. In some example embodiments, as shown in FIG. 2, a common synchronization initialization (SI) job 210 may be used to initialize the state indications of the execution conditions for the jobs 240. For example, if the execution condition for the job 240-1 is defined as the counter reaching zero, the SI job 210 initializes the counter with a value of 2, since the job 240-1 depends on two jobs. In the following, the SD jobs 220 and the SI job 210 may be collectively referred to as synchronization jobs or individually referred to as a synchronization job.

It is to be understood that the number of jobs and the dependencies of the functional jobs as shown in FIG. 2 are for purpose of illustration without any limitation. In example embodiments of the present disclosure, there can be any suitable number of jobs.

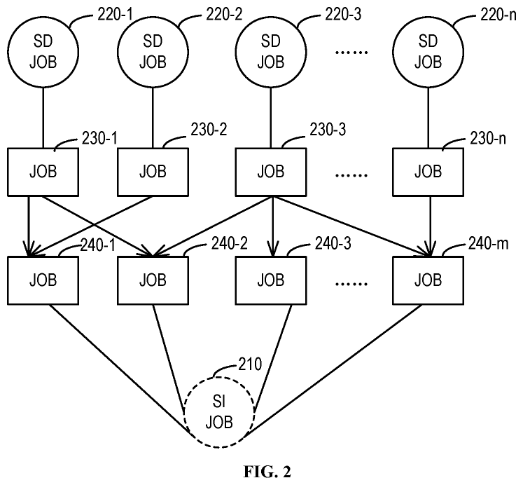

FIG. 3 illustrates an example procedure 300 of synchronization processing according to some example embodiments of the present disclosure. In general, the procedure 300 comprises three stages, resource reservation 310, job configuration 320 and job scheduling and execution 330.

Resource reservation 310 may be executed during a startup stage of the device 101. The processing unit 110 may reserve a computing resource for atomic operations of job synchronization. For example, a computation unit 140 with specific memory may be reserved and dedicated for the job synchronization. During running time, the SD jobs 220 and the optional SI job 210 are executed using the reserved resource, for example, in the reserved computation unit 140.

The job configuration 320 and job scheduling and execution 330 are executed each processing cycle. For example, the job configuration 320 and job scheduling and execution 330 are executed each subframe in the LTE communication environment and executed each slot in the NR communication environment.

During the job configuration 320, the functional jobs 230 and 240, the SD jobs 220 and the optional SI job 210 are configured, for example, by the processing unit 110. In addition, the execution conditions may be set during the job configuration 320.

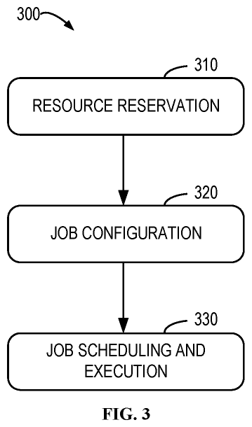

FIG. 4 illustrates an example process of job configuration 310 according to some example embodiments of the present disclosure. As shown in FIG. 4, in some example embodiments, if there are upstream jobs of the independent jobs 230, the upstream jobs may be configurated at block 440. At blocks 410-1, . . . , 410-n, which are collectively referred to as blocks 410 or individually referred to as block 410, the independent jobs 230 are configured, respectively. For example, the job 230-1 is configured at block 410-1 and the job 230-n is configured at block 410-n. At block 410, the processing unit 110 may prepare parameters of the job 230.

At blocks 420-1, . . . , 420-n, which are collectively referred to as blocks 420 or individually referred to as block 420, the SD jobs 220 are configured, respectively. For example, the SD job 220-1 is configured at block 420-1 and the SD job 220-n is configured at block 420-n. In the example of FIG. 2, the independent jobs 230 and the corresponding SD jobs 220 are configured alternatively. However, this is for the purpose of illustration without any limitation to the protection scope. In some example embodiments, the SD jobs 220 may be configured after all the independent jobs 230 are configurated.

At block 420, the SD job 420 is configurated to determine whether the execution condition for a job 240 depending on the corresponding job 230 is met and trigger execution of the job 240 if the execution condition is met. In the example embodiments where the SI job 210 is used, the SD job 420 may configurated to check the state indication of the execution condition for the job 240 and trigger the execution of the job 240 if the state indication indicating that the execution condition is met.

To this end, the processing unit 110 may configure the SD job 420 with information about the execution condition. In the example where a counter is used, the SD job 420 may be configured with a memory address of the counter or an index which can be used to access the memory address. As such, the SD job 420, when executed, can check the value of the counter to determine whether the execution condition is met. The processing unit 110 may further configure the SD job 420 with information about the one or more dependent jobs 240, for example an identification or index of the one or more dependent jobs 240. In this way, the SD job 220 is aware of which job to trigger when an execution condition is met. As an example, the SD job 220-1 is configured with information about the state indications (such as counters or bitmaps) for the jobs 240-1 and 240-2 as well as information about the jobs 240-1 and 240-2.

At blocks 430-1, . . . , 430-n, which are collectively referred to as blocks 430 or individually referred to as block 430, the dependent jobs 240 are configured, respectively. For example, the job 240-1 is configured at block 430-1 and the job 240-m is configured at block 430-m. At block 430, the processing unit 110 may prepare parameters of the job 240.

At block 450, the SI job 210 may be configurated. Specifically, the SI job 210 is configured to initialize the state indication of the execution condition for each job 240 with a specified value. For example, if the counter is used as the state indication and the execution condition is the counter reaching zero, the SI job 210 is configured with initial values of the counters for the jobs 240. The initial value may be related to the number of jobs 230 on which a job 240 depend and also related to the implementation of the SD jobs 230, as will be described below. In such example embodiments, configuring the SI job 210 after the SD jobs 220 can reduce the difficulty in programming of the jobs.

In some example embodiments, if there are downstream jobs of the dependent jobs 240, the downstream jobs may be configurated at block 460. It is to be understood that the configuration order of different jobs is only for the purpose of illustration without any limitation. The functional jobs and synchronization jobs can be configured in any suitable order.

Reference is now made back to FIG. 3. The job scheduling and execution 330 occurs after the job configuration 320. In general, during the job scheduling and execution 330, the SI job 210 is scheduled and executed using the reserved computing resource and then all independent jobs 230 are scheduled and executed.

The SD jobs 220 are scheduled following the independent jobs 230 and executed using the reserved computing resource. The SD jobs 220 are executed atomically to check the execution conditions. When an SD job 220 determines that an execution condition for a dependent job 240 is met, the SD job 220 triggers execution of the dependent job 240. Then, the dependent job 240 is scheduled and executed.

### Example Process of Job Scheduling and Execution

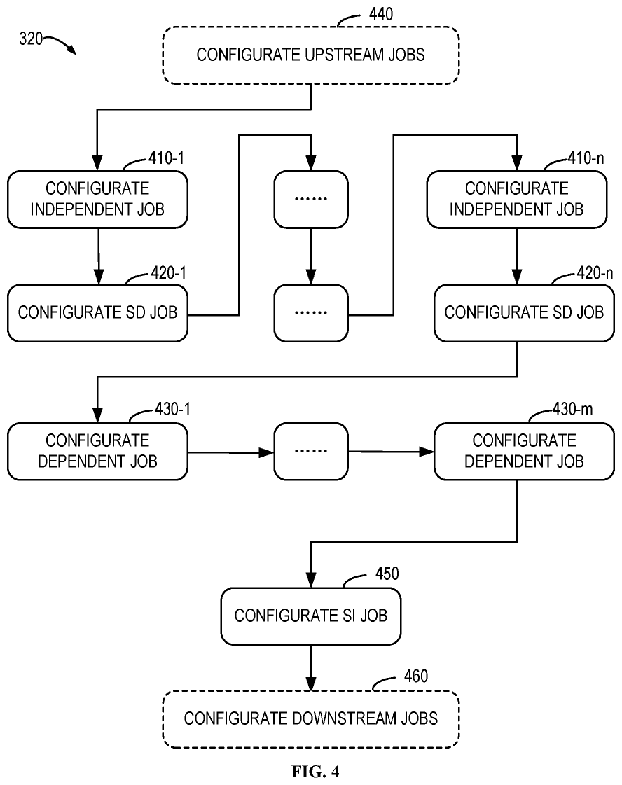

The job scheduling and execution 330 is now described in detail with FIG. 5. FIG. 5 illustrates an example process of job scheduling and execution 330 according to some example embodiments of the present disclosure. At block 501, the SI job 210 is scheduled. At block 502, the SI job 210 is executed using the reserved computing resource, for example in the reserved computation unit 140. By executing the SI job 210, the execution conditions for the jobs 240 are specified and the state indications of the execution conditions are initialized.

In the example embodiments with upstream jobs, the upstream jobs may be scheduled at block 511 and executed at block 512. At blocks 521-1, . . . , 521-n, the independent jobs 230-1, . . . , 230-n are scheduled, respectively. At blocks 522-1, . . . , 522-n, the independent jobs 230-1, . . . , 230-n are executed, respectively. The independent jobs 230-1, . . . , 230-n may be executed using any suitable computing resource and in any suitable order. The completion order of the independent jobs 230-1, . . . 230-n are not guaranteed.

At blocks 531-1, . . . , 531-n, the SD jobs 220-1, . . . , 220-n are scheduled, respectively. Each SD job 220 is scheduled following the completion of the corresponding independent job 230. For example, the SD job 220-1 is scheduled following the job 230-1 is completed. When the reserved computing resource is available, the scheduled SD jobs 220-1, . . . , 220-n are executed one by one atomically at blocks 532-1, . . . , 532-n, which are collectively referred to as blocks 532 or individually referred to as block 532.

For each dependent job 240 which depends on the job 230 corresponding to a SD job 220, a sub-process 560 is implemented by executing the SD job 220 at block 532. In some example embodiments, at block 533, the SD job 220 may update the state indication of the execution condition for the dependent job 240. At block 534, the SD job 220 determines whether the execution condition for the dependent job 240 is met. If the execution condition for the dependent job 240 is met, the sub-process 560 proceeds to block 535. At block 535, the SD job 220 triggers execution of the dependent job 240. In some example embodiments, the SD job 220 may submit the dependent job 240 to a job queue. Alternatively, the SD job 220 may trigger the execution of the dependent job 240 in any suitable manner.

If at block 534 it is determined that the execution condition for the dependent job 240 is not met, the SD job 220 may be completed without triggering the execution of the dependent job 240. In this way, for a dependent job 240 depending on a plurality of independent jobs, the last executed SD job triggers execution of the dependent job 240.

As an example, after the job 230-1 is complete, the corresponding SD job 220-1 is scheduled and executed. The SD job 220-1 updates the state indication of the execution condition for the job 240-1 and the state indication of the execution condition for the job 240-2. For example, the SD job 220-1 may decrease the counter for the job 240-1 by 1 and decrease the counter for the job 240-2 by 1. If the counter for the job 240-1 reaches zero, the SD job 220-1 determines that the execution condition for the job 240-1 is met. This means that both the jobs 230-1 and 230-2 on which the job 240-1 is dependent are completed. Then, the SD job 220-1 may submit the job 240-1 to a job queue. If the counter for the job 240-2 does not reaches zero, the SD job 220-1 determines that the execution condition for the job 240-2 is not met. This means that the job 230-3 might not be completed. Accordingly, the SD job 220-1 does not trigger execution of the job 240-2.

In the sub-process 560, the SD job 220 first updates the state indication (for example, the counter) and then checks the execution condition based on the updated state indication. In such example embodiments, the initial value of the state indication or the execution condition for a particular dependent job 240 is directly based on the number of independent jobs 230 of the dependent job 240.

As an example, the execution condition for the job 240-2 may be defined as the counter for the job 240-2 reaching zero. Then, the initial value of the counter set by the SI job 210 is two, since the job 240-2 depends on two jobs, that is the job 230-1 and the job 230-3. Accordingly, each of the SD jobs 220-1 and 220-3 when executed decreases the counter for the job 240-2 by 1. As another example, since the job 240-2 depends on two jobs, the execution condition for the job 240-2 may be defined as the counter for the job 240-2 reaching two. Then, the initial value of the counter set by the SI job 210 is zero. Accordingly, each of the SD jobs 220-1 and 220-3 when executed increases the counter for the job 240-2 by 1.

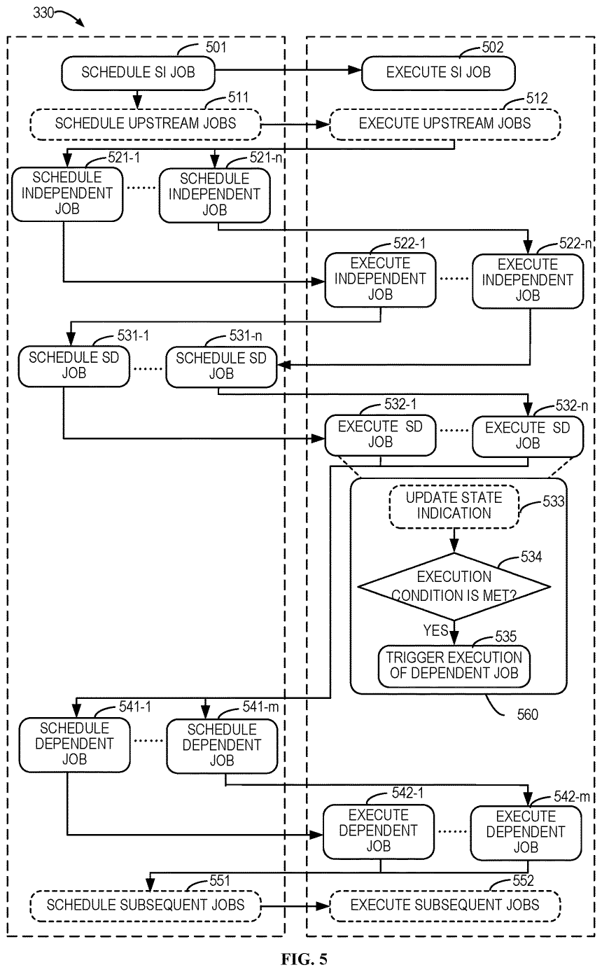

Alternatively, in some example embodiments, the SD job 220 may first check the execution condition based on the state indication. The SD job 220 may then trigger the execution of the dependent job or update the state indication. Such example embodiments are described with reference to FIG. 6 below.

At blocks 541-1, . . . , 541-m, the dependent jobs 240-1,. 240-m are scheduled, respectively. At blocks 542-1,. 542-m, the dependent jobs 240-1, . . . , 240-m are executed, respectively. The dependent jobs 240-1, . . . , 240-m may be executed using any suitable computing resource. In some example embodiments, if there are downstream jobs, the downstream jobs may be scheduled at block 551 and executed at block 552.

As can be seen from the above description, the SD job is used to ensure that the dependent job is executed correctly. Such a software implementation alleviates the demand for of hardware resources. As such, a synchronization mechanism is achieved with reduced cost. For example, the demand for more powerful but expensive SoC is avoided.

FIG. 6 illustrates an example process 600 of handling synchronization jobs according to some example embodiments of the present disclosure. As described above, during resource reservation 310, a dedicated computing resource is reserved for the synchronization jobs, including the SD jobs 220 and the SI job 210. For example, a computation unit 140 is reserved. The SD jobs 220 and the SI job 210 are prepared and pushed into a specific queue.

To handle the synchronization jobs, at block 610, a status register associated with the reserved computing resource is monitor. For example, a job handling program may keep running in the reserved computation unit 140 and polling the status register of the reserved computation unit 140. At block 620, it is determined whether the status register has a specified value. When the value of the status register is the specified value, it means a synchronization job has been received at the computing resource and is ready for execution. Then, the process 600 proceeds to block 630. At block 630, it is determined whether the SI job 210 is received.

If the SI job 210 is received, then the SI job 210 is executed using the reserved computing resource. That is, the process 600 proceeds to block 640. At block 640, the state indications of the execution conditions for the jobs 240 are initialized.

If a SD job 220 is received, then the SD job 220 is executed using the reserved computing resource. That is, the process 600 proceeds to the sub-process 601. At block 650, the SD job 220 determines whether the execution condition for the dependent job 240 is met. If the execution condition for the dependent job 240 is met, the sub-process 601 proceeds to block 660. At block 660, execution of the dependent job 240 is triggered. For example, the dependent job 240 may be submitted to a job queue for execution.

If the execution condition for the dependent job 240 is not met, the sub-process 601 proceeds to block 670. At block 670, the state indication of the execution condition for the dependent job 240 is updated.

Regardless of which synchronization job is executed, at block 680, the status register is reset for next round of execution. In such example embodiments, by monitoring the status register, the synchronization jobs can be executed timely, resulting in an improved performance.

Compared to the sub-process 560, in the sub-process 601, the SD job 220 first checks the execution condition based on the state indication. Then, the SD job 220 may update the state indication (for example, the counter) or trigger execution of the dependent job 240. In such example embodiments, the last executed SD job 220 for the dependent job 240 triggers execution of the dependent job 240 without updating the state indication.

As an example, the execution condition for the job 240-2 may be defined as the counter for the job 240-2 reaching zero. Then, the initial value of the counter set by the SI job 210 may be one, since the job 240-2 depends on two jobs, that is, the job 230-1 and the job 230-3. Accordingly, the last executed one of the SD jobs 220-1 and 220-3 does not decrease the counter for the job 240-2 and the other one decreases the counter for the job 240-2 by 1. As another example, since the job 240-2 depends on two jobs, the execution condition for the job 240-2 may be defined as the counter for the job 240-2 reaching one. Then, the initial value of the counter set by the SI job 210 is zero. Accordingly, the last executed one of the SD jobs 220-1 and 220-3 does not increase the counter for the job 240-2 but the other one increases the counter for the job 240-2 by 1.

It is to be understood that the order of updating the state indication and checking the execution condition is flexible according to the example embodiments of the present disclosure. In some example embodiments, the SD job 220 may first check the execution condition and update the state indication if the execution condition is not met, for example as shown in the sub-process 601. Alternatively, in some example embodiments, the SD job 220 may first update the state indication and then check the execution condition, for example as shown in the sub-process 560.

In summary, for a specific dependent job 240, a SD job 220 performs at least one of the following: updating the state indication of the execution condition for the specific dependent job 240 or triggering execution of the specific dependent job 240.

### Example Use Case

In example embodiments of the present disclosure, restriction of hardware resources (for example, hardware queues and hardware counters) can be alleviated. Thus, lots of jobs can be synchronized in this way. In particular, in the communication environment, massive cells (for example, 64 cells in NR) can be supported. The demand for more powerful but expensive SoC can be avoided.

To better understand the advantages of the present disclosure, an example use case is described. In the communication environment 100, the device 101 needs to execute two types of jobs including Frequency Offset Correction (FOC) job and Channel Estimation (CE) job. The device 101 may transmit five demodulation reference signal (DMRSs) each over one symbol to the device 102. For a DMRS over a symbol, there is an FOC job and a CE job. Each CE job depends on the FOC job for the same DMRS and the CE job for the previous DMRS.

Specifically, the CE job of the 1st DMRS depends on the FOC job of the 1st DMRS. The CE job of the 2nd DMRS depends on the FOC job of the 2nd DMRS and the CE job of the 1st DMRS. The CE job of the 3rd DMRS depends on the FOC job of the 3rd DMRS and the CE jobs of the 1st, 2nd DMRSs. The CE job of the 4th DMRS depends on the FOC job of 4th DMRS and the CE jobs of the 1st, 2nd and 3rd DMRSs. The CE job of the 5th DMRS depends on the FOC job of the 5th DMRS and the CE jobs of the 1st, 2nd, 3rd and 4th DMRSs. It is assumed that there are N cells in the environment 100.

Take the counter-based dependencies mechanism for example. To implement the dependencies above, 1 common hardware queue, N cell specific hardware queues and 4*N hardware counters are used. In the case of NR communication, the cell number N is 64. Accordingly, 65 hardware queues and 256 hardware counters are used.

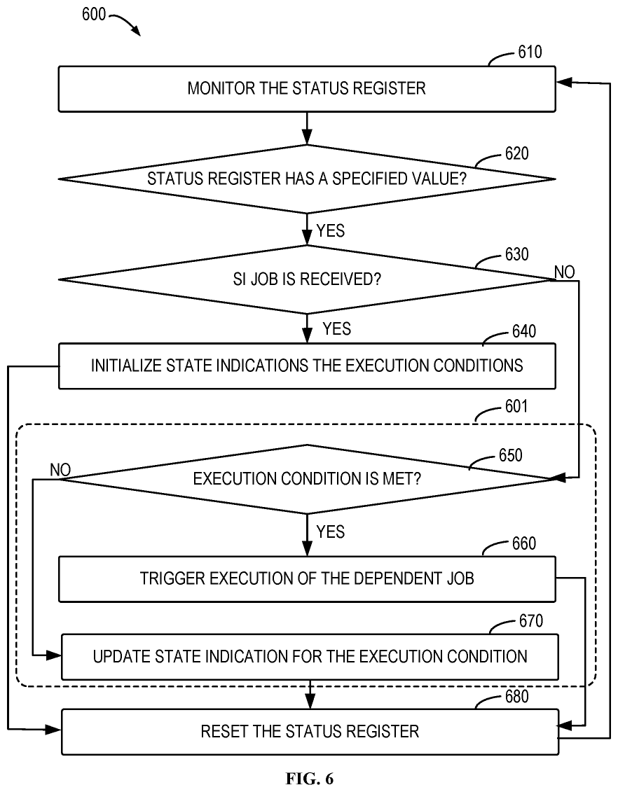

FIG. 7 illustrates example dependencies of communication jobs according to some example embodiments of the present disclosure. As shown in FIG. 7, a common FOC queue 701 is used to store the FOC jobs of different DMRSs, a common synchronization queue 702 is used to store the SD jobs and a common CE queue 703 is used to store the CE jobs of different DMRSs.

The FOC job 711 of the 1st DMRS triggers the CE job 712 of the 1st DMRS. The CE job 712 of the 1st DMRS triggers the SD job 715 corresponding to the CE job 712 of the 1st DMRS. The FOC job 721 of the 2nd DMRS triggers the SD job 720 corresponding to the FOC job 721 of the 2nd DMRS. The SD job 715 and the SD job 720 check the execution condition for the CE job 722 of the 2nd DMRS. The last executed one of these two SD jobs triggers the CE job 722 of the 2nd DMRS.

The CE job 722 of the 2nd DMRS trigger the SD job 725 corresponding to the CE job 722 of the 2nd DMRS. The FOC job 731 of the 3rd DMRS triggers the SD job 730 corresponding to the FOC job 731 of the 3rd DMRS. The SD job 715, the SD job 725 and the SD job 730 check the execution condition for the CE job 732 of the 3rd DMRS. The last executed one of these three SD jobs triggers the CE job 732 of the 3rd DMRS.

The CE job 732 of the 3rd DMRS trigger the SD job 735 corresponding to the CE job 732 of the 3rd DMRS. The FOC job 741 of the 4th DMRS triggers the SD job 740 corresponding to the FOC job 741 of the 4th DMRS. The SD job 715, the SD job 725, the SD job 735 and the SD job 740 check the execution condition for the CE job 742 of the 4th DMRS. The last executed one of these four SD jobs triggers the CE job 742 of the 4th DMRS.

The CE job 742 of the 4th DMRS trigger the SD job 745 corresponding to the CE job 742 of the 4th DMRS. The FOC job 751 of the 5th DMRS triggers the SD job 750 corresponding to the FOC job 751 of the 5th DMRS. The SD job 715, the SD job 725, the SD job 735, the SD job 745 and the SD job 750 check the execution condition for the CE job 752 of the 5th DMRS. The last executed one of these five SD jobs triggers the CE job 752 of the 5th DMRS.

As can be seen from the above description, 3 common hardware queues are used and not hardware counter is used. When supporting more cells, the number of used hardware queues is not increased. Compared with the counter-based dependencies mechanism, for 64 cells configurations, total 62 hardware queues and 256 hardware counters are saved.

### Example Methods

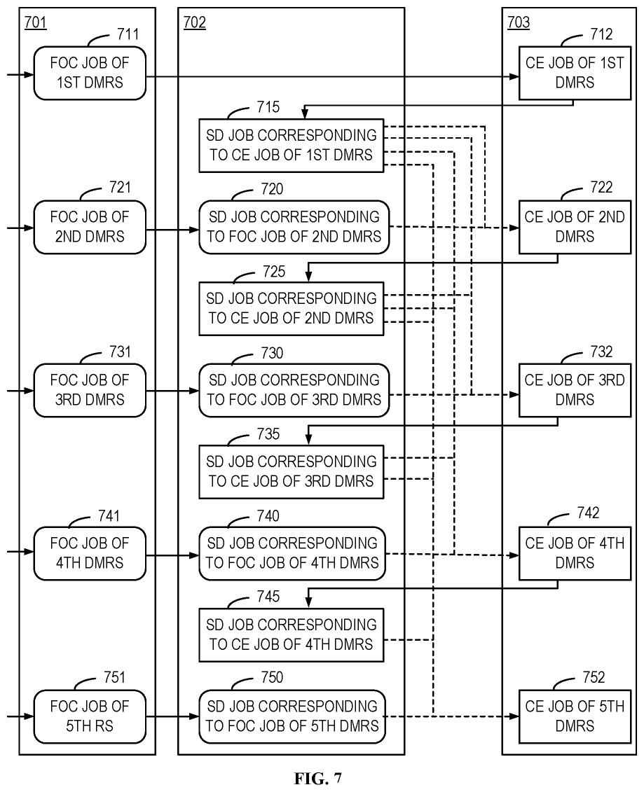

FIG. 8 shows a flowchart of an example method 800 implemented at a device in accordance with some example embodiments of the present disclosure. For the purpose of discussion, the method 800 will be described from the perspective of the device 101 in FIG. 1A.

At block 810, the device 101 executes a first job. A second job depends on the first job. At block 820, the device 101 determines whether the first job is completed. If the first job is completed, the method 800 proceeds to block 830.

At block 830, the device 101 determines whether a first execution condition for the second job is met by executing a dispatching job corresponding to the first job. If the first execution condition is met, the method 800 proceeds to block 840. At block 840, the device 101 triggers execution of the second job by executing the dispatching job.

In some example embodiments, the method 800 further comprises initializing a state indication of the first execution condition by executing an initialization job common to a plurality of jobs comprising the second job.

In some example embodiments, determining whether the first execution condition for the second job is met comprises: in accordance with a determination that the first job is completed, updating the state indication by executing the dispatching job; and in accordance with a determination that the updated state indication has a specified value, determining that the first execution condition is met.

In some example embodiments, the method 800 further comprises: executing a third job, the second job depending on the third job; and in accordance with a determination that the third job is completed, updating the state indication for the first execution condition by executing a further dispatching job corresponding to the third job.

In some example embodiments, the further dispatching job and the dispatching job are executed sequentially.

In some example embodiments, the method 800 further comprises: configuring the dispatching job to check the state indication for the second job and trigger the execution of the second job if the state indication indicating that the execution condition is met; and configuring the initialization job to initialize state indications of execution condition for the plurality of jobs.

In some example embodiments, the method 800 further comprises: in accordance with a determination that the first job is completed, determining whether a second execution condition for a fourth job is met by executing the dispatching job, the fourth job depending on the first job; and in accordance with a determination that the second execution condition is met, triggering execution of the fourth job by executing the dispatching job In some example embodiments, the method 800 further comprises: monitoring a status register associated with a computing resource reserved for executing the dispatching job; and in accordance with a determination that the status register has a specified value, executing the dispatching job using the computing resource.

In some example embodiments, triggering execution of the second job by executing the dispatching job comprises: in accordance with a determination that the first execution condition is met, submitting the second job into a job queue for execution by executing the dispatching job.

In some example embodiments, the first and second jobs are used for communication between the device and at least one further device.

In some example embodiments, the device comprises a network device and the at least one further device comprises a terminal device.

In this way, a software implementation is employed to synchronize dependent and independent jobs. Restrictions of hardware resources (for example, hardware queues, hardware counters) are reduced. As such, the demand for more powerful but expensive SoC is avoided. Moreover, the execution condition can be defined in a flexible way.

### Example Apparatus, Device and Medium

In some example embodiments, an apparatus capable of performing the method 800 (for example, the device 101 in FIG. 1A) may comprise means for performing the respective operations of the method 800. The means may be implemented in any suitable form. For example, the means may be implemented in a circuitry or software module. The apparatus may be implemented as or included in the device 101 in FIG. 1A.

In some example embodiments, the apparatus comprises: means for executing a first job on which a second job depends; means for in accordance with a determination that the first job is completed, determining whether a first execution condition for the second job is met by executing a dispatching job corresponding to the first job; and means for in accordance with a determination that the first execution condition is met, triggering execution of the second job by executing the dispatching job.

In some example embodiments, the apparatus further comprises: means for initializing a state indication of the first execution condition by executing an initialization job common to a plurality of jobs comprising the second job.

In some example embodiments, the means for determining whether the first execution condition for the second job is met comprises: means for in accordance with a determination that the first job is completed, updating the state indication by executing the dispatching job; and means for in accordance with a determination that the updated state indication has a specified value, determining that the first execution condition is met.

In some example embodiments, the apparatus further comprises: means for executing a third job, the second job depending on the third job; and means for in accordance with a determination that the third job is completed, updating the state indication for the first execution condition by executing a further dispatching job corresponding to the third job.

In some example embodiments, the further dispatching job and the dispatching job are executed sequentially.

In some example embodiments, the apparatus further comprises: means for configuring the dispatching job to check the state indication for the second job and trigger the execution of the second job if the state indication indicating that the execution condition is met; and means for configuring the initialization job to initialize state indications of execution condition for the plurality of jobs.

In some example embodiments, the apparatus further comprises: means for in accordance with a determination that the first job is completed, determining whether a second execution condition for a fourth job is met by executing the dispatching job, the fourth job depending on the first job; and means for in accordance with a determination that the second execution condition is met, triggering execution of the fourth job by executing the dispatching job.

In some example embodiments, the apparatus further comprises: means for monitoring a status register associated with a computing resource reserved for executing the dispatching job; and means for in accordance with a determination that the status register has a specified value, executing the dispatching job using the computing resource.

In some example embodiments, the means for triggering execution of the second job by executing the dispatching job comprises: means for in accordance with a determination that the first execution condition is met, submitting the second job into a job queue for execution by executing the dispatching job.

In some example embodiments, the first and second jobs are used for communication between the apparatus and at least one further apparatus.

In some example embodiments, the apparatus comprises a network device and the at least one further apparatus comprises a terminal device.

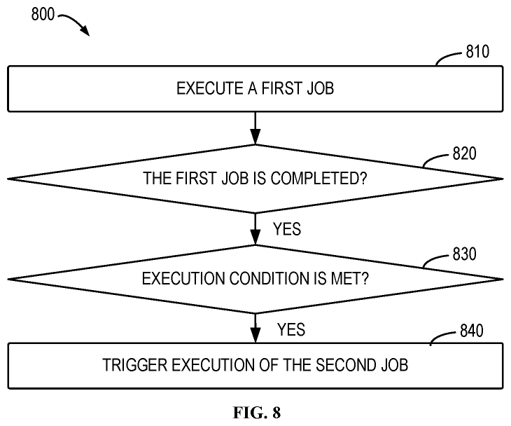

FIG. 9 is a simplified block diagram of a device 900 that is suitable for implementing example embodiments of the present disclosure. The device 900 may be provided to implement a communication device, for example, the device 101 as shown in FIG. 1A. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 3 to FIG. 6 and FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

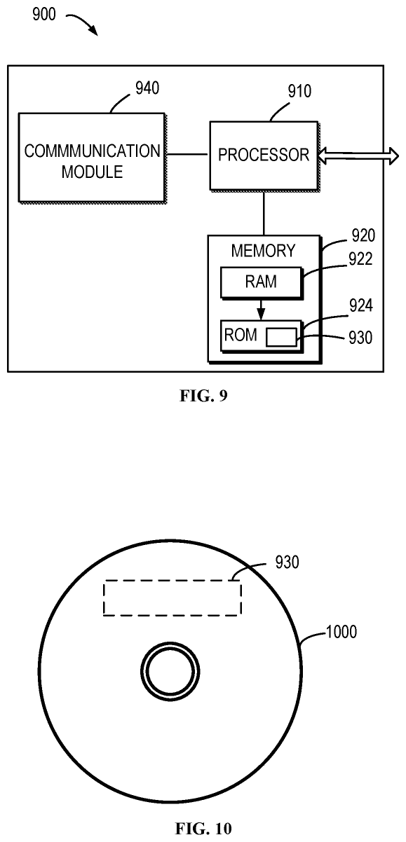

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A device comprising:
at least one processor; and
at least one memory storing instructions that, when executed by the at least one processor, cause the device at least to perform:
executing a first job on which a second job depends;
in accordance with a determination that the first job is completed, determining whether a first execution condition for the second job is met by executing a dispatching job corresponding to the first job; and
in accordance with a determination that the first execution condition is met, triggering execution of the second job by executing the dispatching job.

2. The device of claim 1, wherein at least one memory storing instructions that, when executed by the at least one processor, further cause the device to perform:
initializing a state indication of the first execution condition by executing an initialization job common to a plurality of jobs comprising the second job.

3. The device of claim 2, wherein determining whether the first execution condition for the second job is met comprises:
in accordance with a determination that the first job is completed, updating the state indication by executing the dispatching job; and
in accordance with a determination that the updated state indication has a specified value, determining that the first execution condition is met.

4. The device of claim 2, wherein at least one memory storing instructions that, when executed by the at least one processor, further cause the device to perform:
executing a third job, the second job depending on the third job; and
in accordance with a determination that the third job is completed, updating the state indication for the first execution condition by executing a further dispatching job corresponding to the third job.

5. The device of claim 4, wherein the further dispatching job and the dispatching job are executed sequentially.

6. The device of claim 2, wherein at least one memory storing instructions that, when executed by the at least one processor, further cause the device to perform:
configuring the dispatching job to check the state indication for the second job and trigger the execution of the second job if the state indication indicating that the execution condition is met; and
configuring the initialization job to initialize state indications of execution condition for the plurality of jobs.

7. The device of claim 1, wherein at least one memory storing instructions that, when executed by the at least one processor, further cause the device to perform:
in accordance with a determination that the first job is completed, determining whether a second execution condition for a fourth job is met by executing the dispatching job, the fourth job depending on the first job; and
in accordance with a determination that the second execution condition is met, triggering execution of the fourth job by executing the dispatching job.

8. The device of claim 1, wherein at least one memory storing instructions that, when executed by the at least one processor, further cause the device to perform:
monitoring a status register associated with a computing resource reserved for executing the dispatching job; and
in accordance with a determination that the status register has a specified value, executing the dispatching job using the computing resource.

9. The device of claim 1, wherein triggering execution of the second job by executing the dispatching job comprises:
in accordance with a determination that the first execution condition is met, submitting the second job into a job queue for execution by executing the dispatching job.

10. The device of claim 1, wherein the first and second jobs are used for communication between the device and at least one further device.

11. The device of claim 10, wherein the device comprises a network device and the at least one further device comprises a terminal device.

12. A method comprising:
executing a first job on which a second job depends;
in accordance with a determination that the first job is completed, determining whether a first execution condition for the second job is met by executing a dispatching job corresponding to the first job; and
in accordance with a determination that the first execution condition is met, triggering execution of the second job by executing the dispatching job.

13. The method of claim 12, further comprising:
initializing a state indication of the first execution condition by executing an initialization job common to a plurality of jobs comprising the second job.

14. The method of claim 13, wherein determining whether the first execution condition for the second job is met comprises:
in accordance with a determination that the first job is completed, updating the state indication by executing the dispatching job; and
in accordance with a determination that the updated state indication has a specified value, determining that the first execution condition is met.

15. The method of claim 13, further comprising:
executing a third job, the second job depending on the third job; and
in accordance with a determination that the third job is completed, updating the state indication for the first execution condition by executing a further dispatching job corresponding to the third job.

16. (canceled)

17. The method of claim 13, further comprising:
configuring the dispatching job to check the state indication for the second job and trigger the execution of the second job if the state indication indicating that the execution condition is met; and
configuring the initialization job to initialize state indications of execution condition for the plurality of jobs.

18. The method of claim 12, further comprising:
in accordance with a determination that the first job is completed, determining whether a second execution condition for a fourth job is met by executing the dispatching job, the fourth job depending on the first job; and
in accordance with a determination that the second execution condition is met, triggering execution of the fourth job by executing the dispatching job.

19. The method of claim 12, further comprising:
monitoring a status register associated with a computing resource reserved for executing the dispatching job; and
in accordance with a determination that the status register has a specified value, executing the dispatching job using the computing resource.

20. The method of claim 12, wherein triggering execution of the second job by executing the dispatching job comprises:
in accordance with a determination that the first execution condition is met, submitting the second job into a job queue for execution by executing the dispatching job.

21-23. (canceled)

24. A computer readable medium comprising instructions stored thereon for causing an apparatus at least to perform the method of claim 12.
